(19) United States
(12) Patent Application Publication
(10) Pub. No.: US 2008/0171463 A1
(43) Pub. Date: Jul. 17, 2008

(54) Threaded adapter with male connector termination

(76) Inventors: Gary W. Eisenhower, Freeport, IL (US); Mark A. Mantua, Freeport, IL (US)

Correspondence Address: Kris T. Fredrick, Esq.;Patent Services, Honeywell International Inc., 101 Columbia Road, Morristown, NJ, 07962, US

(21) Appl. No.: 11/652,290

(22) Filed: Jan. 11, 2007

(51) Int. Cl. H01R 4/50

(52) U.S. Cl. 439/345

(57) ABSTRACT

A threaded adaptor device for connecting two devices wherein one device to be connected has a threaded opening for connection to a wiring harness and the other device has a pin connector element. The adaptor includes a body portion that is threaded for direct attachment to conventional openings in conduits, cables and the like. Extending down from the threaded body portion is a wiring sub assembly that easily connects to the opening of the conduit. The other end of the threaded body portion includes a connector which preferably is a male connector with one or more pins extending out from the body of the device, electrically connected to the wiring harness, and protected by an outer, hollow member into which the device connector is inserted. Another embodiment is the use of a female connector, depending on the design of the device being connected.

### FIELD OF THE INVENTION

The present invention relates to an adapter for use with limit switches and like devices that have metal or plastic housings. More particularly, the present invention relates to a threaded adapter with wiring for use with such devices that can be installed after the housing has been manufactured.

### BACKGROUND OF THE INVENTION

A variety of devices are manufactured in large quantities and cost is a most critical component of the manufacturing process. For example, limit switches are manufactured with plastic or metal housings that are to be threaded so that the switch may be connected to a conduit or cable at its relief connections. In current manufacturing processes, wiring is run through the conduit or cable and is wired to the basic switch inside the housing. This takes time and money.

There are a number of applications where a device needs to be connected to a cable, conduit or even other device, where not all the components are manufactured by the same organization or company. For example, conduits and cables are products made by one company in bulk, so that the user acquires access to them after they have been installed in a building, machine, factory and the like. The user then introduces a device, such as by way of example, a limit switch that is to be connected to the conduit or cable. The installation of the limit switch or any other device should be as simple as possible.

Accordingly, one advantage of the present invention is to provide a simple, low cost threaded adaptor that is easily installed in a housing after manufacture of the housing.

Another advantage of the present invention is to provide a pre-wired connector so that all that is needed is to mount the product at its point of use and plug in the mating connector.

Other advantages will appear hereinafter.

### SUMMARY OF THE INVENTION

It has now been discovered that the above and other advantages of the present invention may be obtained in the following manner. In its simplest form, the present invention comprises a threaded adaptor with male connector terminations, so that the adaptor may be threaded into a conduit or cable and quickly connected to the wiring using a pre-wired harness. The other end of the adaptor is fitted with a connector element such as a pin style male connector for attachment of the desired device to the conduit or cable.

The adaptor comprises a body portion that is threaded for direct attachment to conventional openings in conduits, cables and the like that have been installed at any desirable location.

Extending down from the threaded body portion is at least one and preferably a plurality of wires forming a wiring sub assembly that easily connects to the opening of the conduit, cable or the like.

At the other end of the threaded body portion is a connector for connection to the device for which the connection is needed. One example of a device to be connected to the cable or conduit through the device of this invention is a limit switch. The connector of this invention may be a male connector, with one or more pins extending out from the body of the device, electrically connected to the wiring harness, and protected by an outer, hollow member into which the device connector is inserted to mate with the male connector. Of course, female connectors, multiple and single pin or slot designs, and the like are contemplated. One preferred connector for use with the present invention is known in the industry is a Deutsch style connector, but other connectors such as Packard, AMP, etc., are also within the scope of this invention.

### BRIEF DESCRIPTION OF THE DRAWINGS

For a more complete understanding of the invention, reference is hereby made to the drawings, wherein like numbers refer to like elements, and in which:

FIG. 1 is a side elevational view of one embodiment of the present invention;

FIG. 2 is a bottom view of the device of FIG. 1;

FIG. 3 is a top, plan view of the device of FIG. 1;

FIG. 4 is a section view of the device of FIG. 1, taken along the line A-A of FIG. 3;

FIG. 5 is a side elevational view of another embodiment of the present invention;

FIG. 6 is a bottom view of the device of FIG. 5;

FIG. 7 is a top, plan view of the device of FIG. 5;

FIG. 8 is a section view of the device of FIG. 5, taken along the line A-A of FIG. 7;

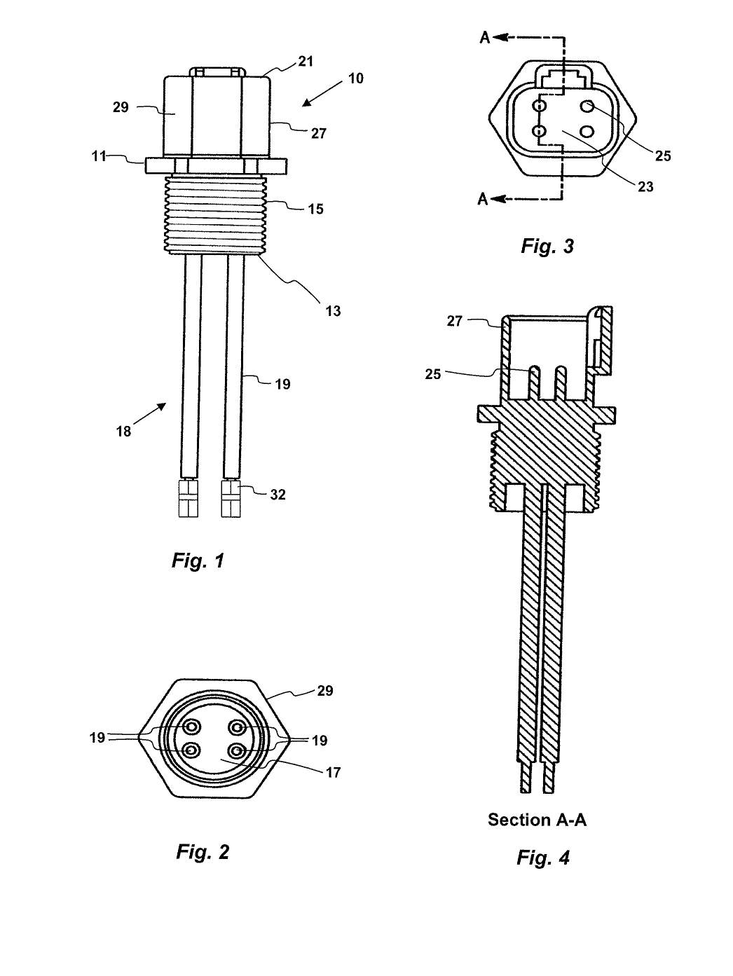

### DETAILED DESCRIPTION OF THE PREFERRED EMBODIMENT

As shown in the drawings, the device of this invention, 10 generally, shows the threaded adaptor of the present invention. The adaptor is intended for connection to a first device having a threaded opening with means for connecting to a wiring harness or wiring assembly, such as a conduit, cable and the like. It is also intended for connection to a second device having a pin connector element.

The device, 10 generally, includes a body portion 11 having a first end 13 threaded 15 for direct attachment to the threaded opening of said first device above. Extending down from and inside body portion first end 13 is a wiring sub assembly 17 having at least one wire 19, and preferably as many wires 19 as are needed for connection to the conventional connection elements in the first device. FIG. 2 illustrates a four wire sub assembly.

Mounted on the second end 21 of body 11 is a connector 23 having a mating connection, in this embodiment as male connector 25 for mating with the second device pin connector element of conventional design.

Surrounding the connectors 25 is an outer, hollow member 27 which protects connectors 25 and provides at least one wrench engaging surface 29, shown in the figures as a hex head surface.

The connector 25 shown in FIGS. 14 is attached to body 11 by over molding the pin/wiring sub assembly that forms connector 25 on to the previously formed body.

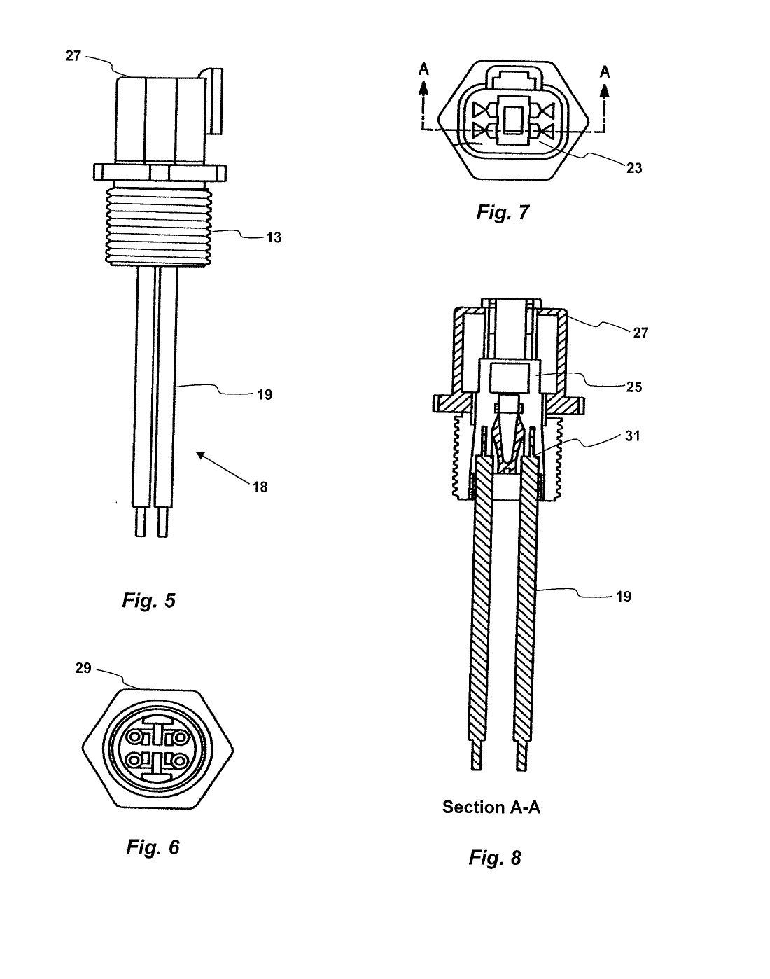

Alternatively, the connector 25 shown in FIGS. 5-8 is attached to body 11 by a snap fit 31, shown as an extension of connector 25 snapping down inside body 11.

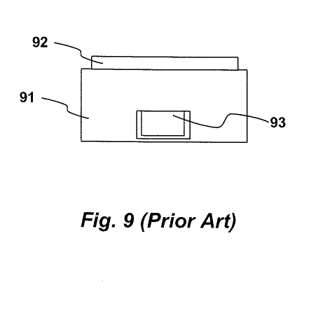

The components of the device of this invention may be formed from plastic, such as by molding, or they may be formed from metal, as by casting or other metal working techniques. As can best be seen in FIGS. 4 and 8, the wires 19 are directly and electrically connected to the male connectors 25 (or female connectors if used) and they can be so connected by forming them as one piece or by connecting two separate elements.

While particular embodiments of the present invention have been illustrated and described, it is not intended to limit the invention, except as defined by the following claims.

1. A threaded adaptor device for connecting a first device having a threaded opening with means for connection to a wiring harness and a second device having a pin connector element, comprising:
a body portion having a first end threaded for direct attachment to a threaded opening and a second end;
a wiring sub assembly on said first end of said body portion for connection to said first device threaded opening wherein the wiring sub assembly comprises a means for electrically connecting to the first device; and
a connector on said second end having a mating connector for mating with said second device pin connector element.

2. The device of claim 1, which further includes an outer, hollow member for surrounding said connector on said second end.

3. The device of claim 2, wherein said outer, hollow member includes at least one wrench engaging surface.

4. The device of claim 3, wherein said wrench engaging surface is hexagonal.

5. The device of claim 3, wherein said connector on said second end is a male connector recessed inside said outer, hollow member.

6. The device of claim 5, wherein said male connector is a Deutsch connector.

7. The device of claim 3, wherein said connector on said second end is a female connector recessed inside said outer, hollow member.

8. The device of claim 1, wherein said wiring sub assembly includes terminal ends comprising a means for crimp connection to said first device having threaded opening means for connection to a wiring harness.

9. The device of claim 1, wherein said connector on said second end is over molded onto said body.

10. The device of claim 1, wherein said connector on said second end is snap fit onto said body.

11. A threaded adaptor device for connecting a first device having a threaded opening with means for connection to a wiring harness and to a second device having a pin connector element, comprising:
a body portion having first threaded end means for direct attachment to a threaded opening and a second end;
wiring sub assembly means on said first end of said body portion for connection to said first device threaded opening wherein the wiring sub assembly comprises a means for electrically connecting to the first device; and
connector means on said second end having a mating connector for mating with said second device pin connector element.

12. The device of claim 11, which further includes outer, hollow member means for surrounding said connector means on said second end.

13. The device of claim 12, wherein said outer, hollow member means includes at least one wrench engaging surface.

14. The device of claim 13, wherein said wrench engaging surface is hexagonal.

15. The device of claim 13, wherein said connector means on said second end is a male connector recessed inside said outer, hollow member.

16. The device of claim 15, wherein said male connector is a Deutsch connector.

17. The device of claim 13, wherein said connector on said second end is a female connector recessed inside said outer, hollow member.

18. The device of claim 11, wherein said wiring sub assembly means comprises terminal end means for crimp connection to said first device having threaded opening means for connection to a wiring harness.

19. The device of claim 11, wherein said connector on said second end is over molded onto said body.

20. The device of claim 11, wherein said connector on said second end is snap fit onto said body.
